(19) United States
(12) Patent Application Publication
(10) Pub. No.: US 2007/0285742 A1
(43) Pub. Date: Dec. 13, 2007

(54) Electronic Page Turner with Improved Pickup Mechanism

(75) Inventors: George Wolberg, Woodmere, NY (US); Ali M. Sadegh, Franklin Lakes, NJ (US)

Correspondence Address: SHELDON MAK ROSE & ANDERSON PC, 100 East Corson Street, Third Floor, PASADENA, CA, 91103-3842, US

(73) Assignee: PAGEFLIP INC., Woodmere, NY (US)

(21) Appl. No.: 11/423,406

(22) Filed: Jun. 9, 2006

(51) Int. Cl. H04N 1/04

(52) U.S. Cl. 358/498

(57) ABSTRACT

An improved automatic page turner for turning selected bound pages, in which the automatic page turner has a frame and one or more pickup arms rotatably coupled to the frame which are capable of intermittently exerting a pressure against the selected bound pages, wherein a page ledge is connected to the frame suitable for separating the selected bound pages from remaining bound pages, together with means for biasing the remaining bound pages against the page ledge, such as one or more helical springs.

### BACKGROUND

The present invention relates to page turner devices suitable for turning bound pages, and specifically to an improvement in the pickup mechanism to reliably separate the page that must be turned. Examples of page turners are disclosed in U.S. Pat. No. 6,935,058 for “Automatic page turner with belt drive element” and U.S. Pat. No. 7,019,203 for “Automatic page turner with turnstile element”, which are incorporated herein. The improved pickup mechanism described here is particularly effective when coupled with the timing belt and attached fingers of the page turner disclosed in U.S. Pat. No. 6,935,058.

Reading books, magazines, and printed materials is an essential activity of daily living. Turning pages of a book or magazine is often cumbersome for avid readers and particularly difficult for musicians and disabled individuals. An automatic page turner can serve as an assistive technology for people with disabilities, the elderly and people with limited upper-body extremity function. A page turner can also furnish hands-free operation to musicians, and provide avid readers with convenient book support and page turning features.

Current automatic page turners handle the page engagement, page transport, and page restraint processes in a variety of ways and come in a variety of types; for example, the rack type, roller type, curl, suction tube, torpedo, subassembly type, flat spring mechanism, scanning type, magnetic tab, rotating page disk, and spring arm. Some current automatic page turners will restrain bound pages to lie flat and open, a few automatic page turners can turn any number of pages with no setup effort, and some provide reversible page turning. One automatic page turner does not require electricity. While another holds the book at a constant height irrespective of the number of book pages.

While there are many automatic page turners currently available, most are not successful because they lack necessary functions, such as, for example, engagement with the page, transport of the page, and restraining the pages of variable sized books to lie flat. Further, other design flaws exist in currently available automatic page turners such as, product unreliability, noisy mechanisms for engaging one page at a time and cumbersome preprocessing where clips or tabs must be attached to each page, or a limit on the number of pages that can be turned. Therefore, there exists a need for an automatic page turner that has none of the disadvantages of current automatic page turners, and has an effective and unobtrusive page restraint mechanism coupled with a page turning process capable of supporting a book of variable size.

### SUMMARY OF THE INVENTION

The present invention relates to an automatic page turner that is compact, silent, portable, reliable, and can accommodate different sizes of bound printed matter, for example, music, books and magazines. In one embodiment of the present invention, the apparatus has a frame; a book support assembly coupled with the frame; two pickup arm assemblies that are coupled to the frame; a motor assembly coupled to the frame; a conveyer assembly coupled to the motor assembly; and an integrated circuit assembly coupled to the frame to control the operation of the page turner.

The frame comprises a shell structure that provides structural support for the motor assembly, the book support, the pickup arm assemblies and the conveyer assembly. In addition, the frame comprises two page ledges and a planar extension that is coupled with the book support assembly. The book support assembly comprises sets of bias springs, a supporting plate, a tilt support, and a foldable cover means. The foldable cover is coupled to the extension of the frame through a hinge means. The tilt support means permits the page turner apparatus to stand upright or at different angles.

The conveyer assembly has a belt, a plurality of fingers rigidly attached to the belt, and at least one actuator coupled to the belt. Each finger may comprise a roller or a slick non-rolling element that can slide smoothly along the surface of the page. A subset of the plurality of fingers holds the bound pages in an open condition. In the shown embodiment, each pickup arm assembly comprises a stepper motor, an actuator, a rigid arm, and an adhesive roller at its distal end. Optionally, the adhesive roller can be replaced by a vacuum or electromagnetic element. Upon rotation of the belt by the motor assembly, the actuator of the pickup arm assembly also energizes the stepper motor causing the pickup arm to lift a page. At least one of the pluralities of fingers turns the lifted page while some of the remaining fingers hold the bound pages in an open condition.

In one embodiment, the motor assembly has a reversible motor, a gear reduction train coupled to the motor, a clutch coupled to the gear reduction train, a sprocket coupled to the clutch, and a pulley with a spring tensioner. The motor assembly can be energized by pressing a button located on the keypad assembly. In another embodiment, the motor assembly is energized by a foot pedal, a breath-controlled switch, a chin switch, or a voice activation device.

The page turner operates as follows. First, the page turner is placed on a horizontal surface and the tilt support at the rear of the unit is positioned to accommodate a comfortable reading angle. When used with music stands, there is no need to open the tilt support as that function is provided by the orientation of the music stand itself. Second, the expandable cover is unfolded to serve as the top half of the book support. The bottom half of the book support is comprised of a spring-loaded plate that is exposed by the lifted expandable cover. A book is then placed between the supporting plate and the page ledges. The springs under the plate apply bias forces to restrain the book between the plate and the plurality of the fingers. The purpose of the fingers is to restrain the book pages and to keep the book open. Then, the topmost group of pages that are to be read are placed on top of the page ledges. The user must then select two settings on the keypad: the type of paper (thin or thick) and the direction of the page turner (forward or reverse). The specified direction activates the stepper motor and the belt drive motor. The stepper motor turns the pickup arm towards the exposed page. The adhesive roller attached to the distal end of the pickup arm comes in contact with that page and presses it against the page ledge. Then, the pickup arm reverses direction to lift the page. In synchronicity with this pickup arm motion, the belt rotates and moves one of the fingers under the lifted page. As the belt continues to rotate, the finger moves across to transport the lifted page to the other side of the book. The remaining fingers act as a turnstile by moving across the surface of the newly exposed page to prevent it from turning freely. Therefore, the fingers perform two important functions: they transport the lifted page across the book and they achieve page restraint by blocking loose pages from turning freely. Finally, the belt stops turning when an actuator on the belt reaches the preset location of a photoelectric sensor. This process can be repeated to turn additional pages by pressing the forward or reverse buttons.

### BRIEF DESCRIPTION OF THE DRAWINGS

FIG. 1 is a perspective view of a page turner which is suitable for using the present invention, shown in a closed form.

FIG. 2 is a perspective view of the page turner of FIG. 1, shown in an open form.

FIG. 3A is a rear view of the page turner shown in FIG. 1.

FIG. 3B is a rear view of another embodiment of the page turner of FIG. 3A.

FIG. 4 is a perspective view of the present invention used with the page turner of FIG. 1, shown with a book.

FIG. 5 is a close up view of the keypad shown in FIG. 2.

FIG. 6 is a side view of FIG. 4.

FIG. 7A is a perspective view of the page turner of FIG. 3A, without the cover, showing the belt and pickup arm assemblies.

FIG. 7B is a perspective view of the page turner of FIG. 3B, without the cover, showing the belt and pickup arm assemblies.

FIG. 8 is a close up view of the belt of FIG. 7A, showing a photoelectric actuator.

FIG. 9A is another perspective view of FIG. 7A.

FIG. 9B is another perspective view of FIG. 7B.

FIG. 10 is a perspective view of the right actuating finger.

FIG. 11 is a perspective view of the pickup arm assembly.

FIG. 12 is a schematic view depicting the page turning process.

### DETAILED DESCRIPTION

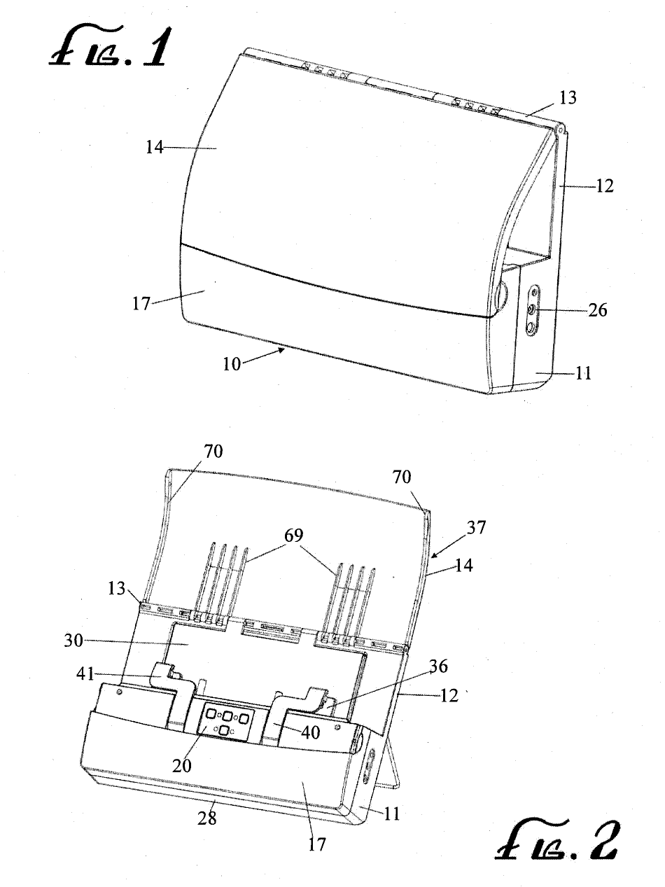

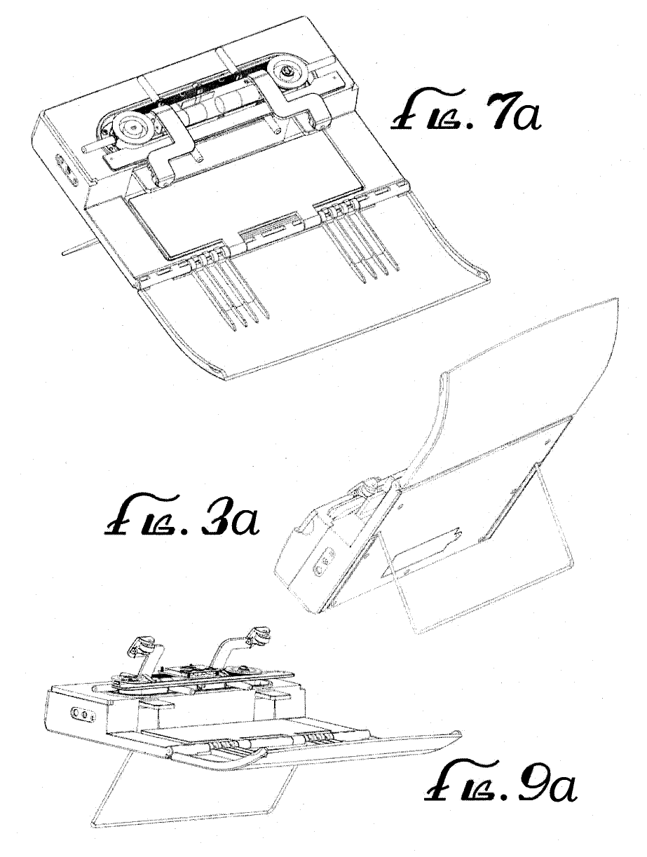

Referring to FIG. 1, an automatic page turner 10 useable with the present invention generally has a frame 11. With reference to FIGS. 2-4 and 6, a book support assembly 37 for holding a book 32 is coupled to the frame. Also, coupled to the frame are a motor assembly (not shown), a conveyer assembly, a pickup arm assembly 50 (shown in FIG. 11), and keypad 20 (shown in FIGS. 2 and 5).

In the embodiment shown in the drawings, the frame 11 comprises a frame extension 12, two page ledges 36, a front cover 17, a battery housing 64, an outlet 26 and a hinge means 13 at the distal end of the frame extension 12. The book support assembly comprises a foldable cover 14, the hinge means 13, a support plate 30, and biasing means in the form of one or more helical compressive springs 29. In a different embodiment of the automatic page turner 10, the frame and the book support assembly are integrated without the foldable cover 14 rotatably connected to the frame extension 12 through hinge means 13.

The book rests on the support plate 30, which is connected to frame extension 12 in part via one or more biasing means for providing bias forces for constraining the book against the page ledges 36, preferably two helical compressive springs 29. Other means of biasing the support plate will be evident to those of ordinary skill with reference to this disclosure. In the shown embodiment, the two page ledges 36 are rigidly connected to the side of the frame 11. The support plate may be bifurcated to support each side of the book independently.

In the shown embodiment, the hinge means 13 rotatably connects the frame extension 12, the support plate 30, and the foldable cover 14. As a design choice, the support plate 30 could optionally be connected to the frame only through the biasing means, or through a combination of biasing means and other mechanisms. In the shown embodiment, the ends of foldable cover 14, frame extension 12 and support plate 30 are fitted together as tong and groove means where protrusions provide rotational limits, i.e., limits their angle of rotation. For example, the foldable cover 14 can have protrusions (not shown) near the ends of the hinge, which provide a stop for the foldable cover 14 and prevents the expandable cover from opening more than 180 degrees. The foldable cover 14 is reinforced with a plurality of ribs 69 and 70 in order to add rigidity to the plates.

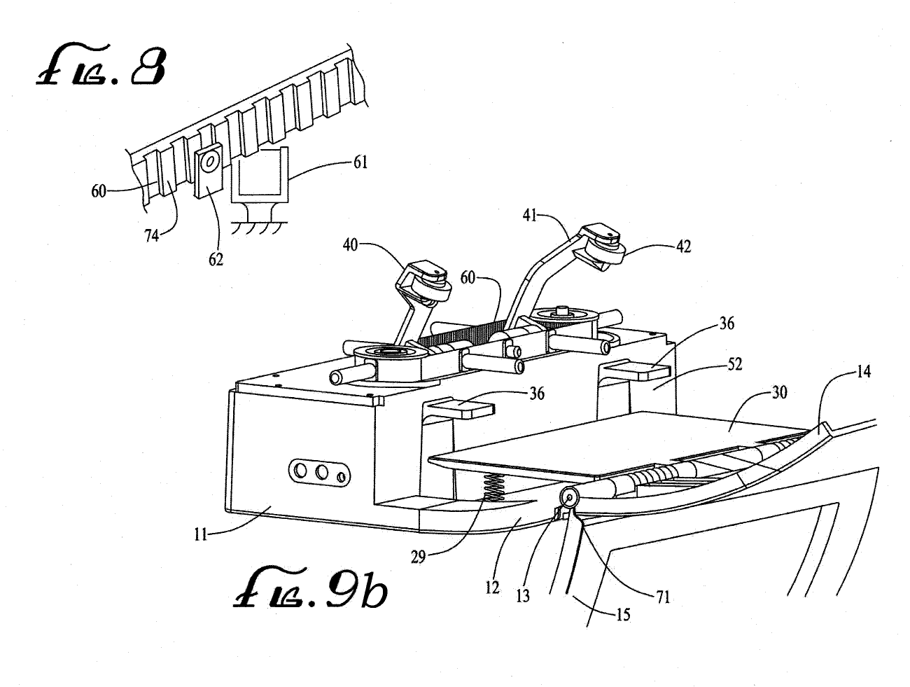

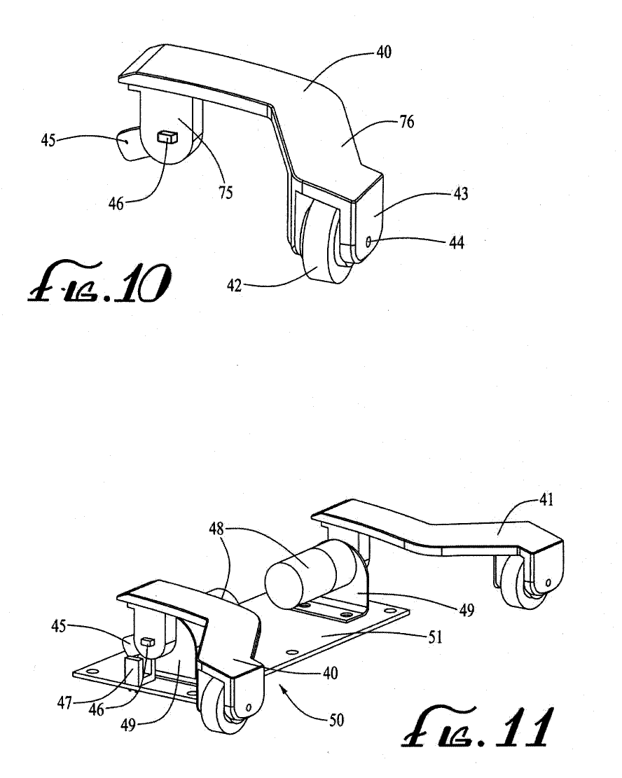

As shown in FIGS. 7A, 7B, 8, 9A, and 9B, the conveyer assembly comprises a timing belt 60, a plurality of fingers 53, 54, 55, 56, 57, 58, a driver sprocket 63, a pulley 59, a compression helical spring 72 (not shown), two actuators 62, and a photoelectric sensor 61. The timing belt 60 is placed around a sheave 73 of the pulley 59, and it is also placed around the driver sprocket 63, where a plurality of timing belt teeth 74 are engaged with a series of teeth (not shown) on the driver sprocket 63. The plurality of fingers 53-58 are preferably cylindrically shaped and are preferably made of a plastic material that is rigidly attached to the timing belt through ultrasonic welding technology. In one embodiment, the plurality of fingers 53-58 each comprise a sleeve roller on a cylindrical shape (not shown). In another embodiment, the plurality of fingers 53-58 each comprise a flat sliding means (not shown) to ease the sliding motion of the finger on the book. As shown in FIG. 7A the two actuators 62 are equally spaced on the belt and are rigidly attached to the belt. The photoelectric sensor 61 is rigidly attached to the base of the frame. As each of the two actuators 62 pass in turn through the open section of the photoelectric sensor 61 the beam of light is obstructed. This provides a signal that is used for stopping the belt. A circuit sufficient to accomplish this will be evident to one of skill with reference to the disclosure. To provide a constant tension in the timing belt, the shaft of pulley 59 is connected to a spring (not shown). One end of the spring (not shown) is rigidly connected to the frame 11 and the other side is connected to the shaft of the pulley that constantly applies a bias force, separating the pulley 59 from the driver sprocket 63, thereby causing tension in the belt. Note that the driver sprocket 63 only rotates with respect to its own shaft and does not move with respect to the frame 11.

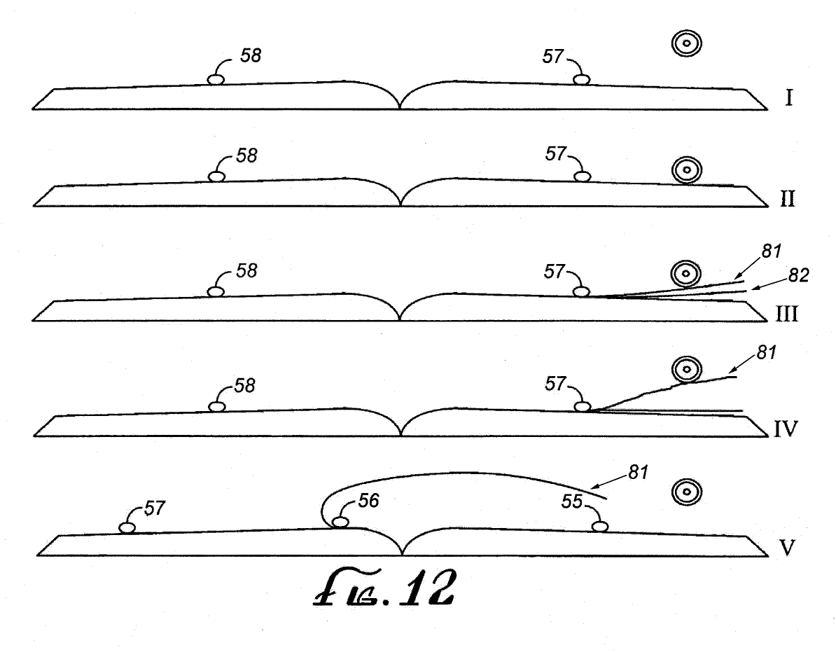

Referring to FIGS. 10 and 11 the pickup arm assembly 50 comprises a right pickup arm 40 and a left pickup arm 41, a stepper motor 48 for each one of the arms, a support bracket 49 for each motor, a base board 51 and two photoelectric sensors 47 for each one of the arms. The output shaft of each stepper motor (not shown) is rigidly connected to the proximal end of the corresponding arm. Each stepper motor is rigidly connected to the base board 51 through the support bracket 49. The base board 51 is also rigidly connected to the frame 11. Each arm comprises a body 76 a roller support 43, a bearing 44 and the adhesive roller 42. At the proximal end of each arm there is a bracket 75, and an extension 45 for actuation of the photoelectric sensor 47. Each stepper motor 48 is rigidly connected to the pickup arms 40 and 41 by a shaft 46. The body 76 is preferably properly curved to the right side of the page turner for the right pickup arm 40, and is preferably properly curved to the left side of the page turner for the left pickup arm 41. These curvatures advantageously extend the contact points to one optimal position away from the spine of the book. The adhesive roller 42 is made of a viscoelastic polymer (soft rubbery material), that has adequate adhesiveness (stickiness) for picking up a book page. The adhesive roller 42 is free to rotate, through the bearing 44, with respect to the roller support 43 and the body 76. The photoelectric sensor 47 is rigidly connected to the base board 51 and is located near the extension 45, such that, as the stepper motor is energized the shaft 46 rotates the arm and the extension 45 crosses through the light beam in the photoelectric sensor 47. This action results in a signal which is used to stop the stepper motor in either direction.

Optionally, in place of a roller support 43, a bearing 44 and the adhesive roller 42, a vacuum mechanism could be used to pick up the book page. If metal clips or metallic tape were affixed to each page, then electromagnets could be used in place of the adhesive rollers.

The motor assembly has a conventional electric motor and a conventional gear reduces train. The output shaft of the motor is coupled to the gear reducer that is coupled to a clutch and the driver sprocket 63. Since these elements are conventional parts and do not contribute to the teaching of this invention, they are not shown.

As shown in FIG. 5, the keypad and control assembly comprises a set of electronic push button keys 21-24 and an integrated circuitry board (not shown) to control the operation of the present invention. The set of buttons include a power button 22 for turning the page turner on or off, a forward button 21 and a reverse button 23 for respectively selecting the forward and reverse page turning directions, and a paper thickness button 24 for specifying whether thin or thick paper will be turned. Small light emitting diodes alongside these buttons provide visual cues of the selected options.

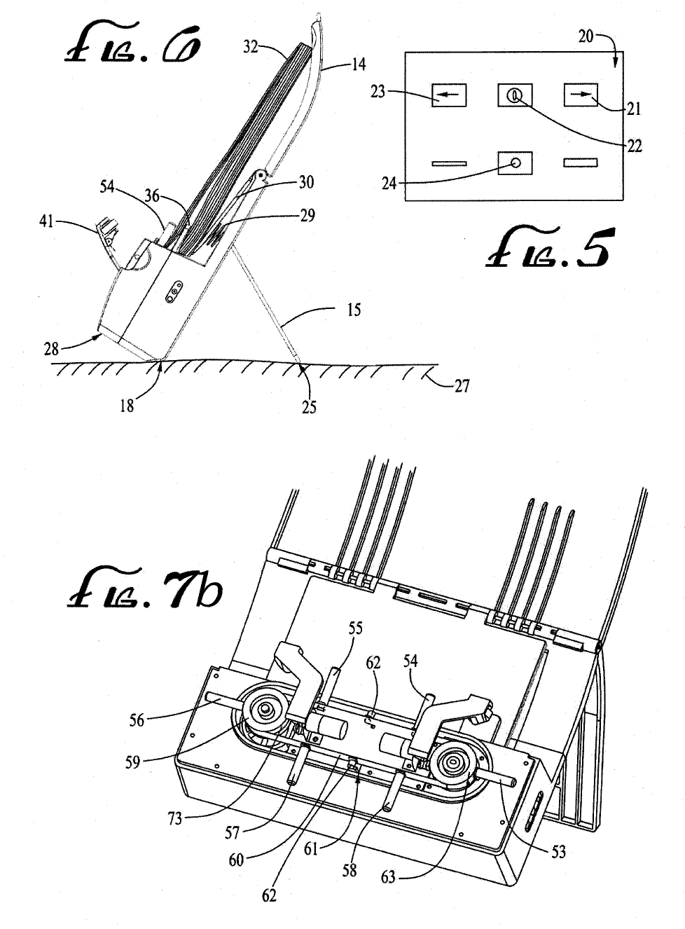

The automatic page turner 10 can be used in a variety of orientations. In the conventional way shown in FIG. 6, the tilt support 15 is extended 45 degrees and the automatic page turner 10 is placed on a table or horizontal plane 27 and is supported by a chamfered surface 18 and a second edge 25. A stop prevents further opening of the tilt support 15 beyond 45 degrees. Then the foldable cover 14 is unfolded to extend about 180 degrees and is stopped by the protrusions 68 from further opening (FIG. 2). This orientation of the automatic page turner 10 is a stable and convenient way of reading books. However, the page turner can be supported by bottom surface 28 for use on a piano ledge or the inclined surface of a music stand. In this case, there is no need to open the tilt support 15.

Once the page turner is opened and is conveniently placed on a table or ledge, the page turner is powered by connecting a power cord between the outlet 26 and a wall outlet. In a portable cordless version of the apparatus, the unit can be powered by a plurality of small conventional dry batteries that are located in the battery housing 64. Note that before the power is turned on, the right pickup arm 40 and the left pickup arm 41 are in the power-off position whereby the adhesive roller 42 is in contact with the two page ledges 36, as shown in FIG. 2. The power button 22 that is conveniently located on the keypad 20 electrically energizes the page turner, and the unit's control system turns the right pickup arm 40 and the left pickup arm 41 away from the page ledges. They remain in that rest position until a page-turn command is given.

Beyond the forward and reverse buttons located on the keypad, other triggers can by employed, such as, for example, wireless foot pedals, breath-controlled switches, chin switches, voice activation devices, gesture recognition devices, and computerized timers. They are used to energize the motor and the stepper motor 48. These triggers require the appropriate switches to be plugged into the outlet 26.

The operation of the automatic page turner 10 according to one embodiment of the present invention will now be considered in more detail. First, as shown in FIG. 6, the book 32 is placed on top of the support plate 30 and under the two page ledges 36 and under the plurality of fingers 53-58. Then, a set of selected pages that are to be read are placed on top of their associated page ledge, and underneath the plurality of fingers 53-58. That is, the book is restrained between the support plate 30 and the plurality of fingers 53-58 and the two page ledges 36. In one embodiment, the user adjusts the velocity profile of the pickup arm to compensate for heavy or light weight paper by pressing the paper thickness button 24 on the keypad.

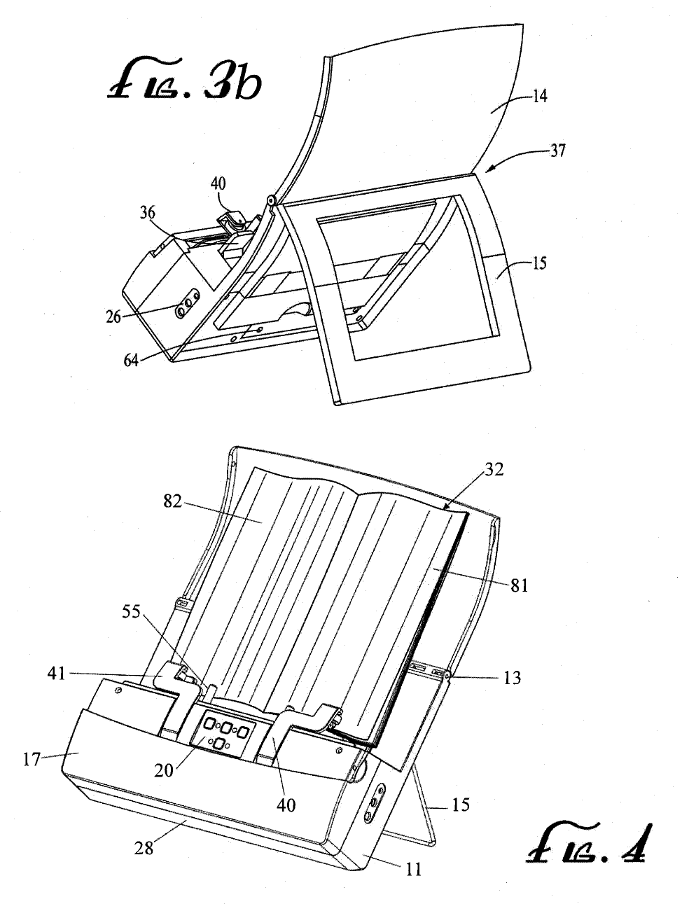

With reference to FIG. 4, pressing the forward button 21 on the keypad 20 the stepper motor rotates the right pickup arm 40 about its pivot point to reach the right page 81. Then, the adhesive roller 42 comes in contact with the right page 81 of the book 32, and presses down and holds its position for a fraction of a second. Note that the roller presses and squeezes against those pages that were placed upon the page ledge that is fixed to the frame. The reversible electric motor is then energized and the gear reductions set and the clutch rotates the driver sprocket 63 and the timing belt 60 in a counterclockwise direction. Then, the right pickup arm 40 rotates away from the right page 81 to lift it up. The velocity of the pickup arm varies according to the preset timing profiles associated with the heavy and light weight paper settings.

As shown in FIG. 12, the act of picking up one page and avoiding subsequent pages from following is facilitated by the fact that the right page 81 is restrained by one of the plurality of fingers 53-58. At first, a subsequent page 83 is apt to follow closely due to suction (negative pressure) between the right page 81 which is being lifted, and the subsequent page 83. The opposing upward force of the pickup arm and the downward force applied by the restraining finger applies shear force necessary to separate any attached pages from page 81. Once the pickup arm lifts up the right page 81 the timing belt 60 rotates one of the plurality of fingers 53-58 counterclockwise and brings it under the lifted right page 81. At this moment the pickup arm continues its upward motion, while the right page 81 is transferred to the left side by the one of the plurality of fingers 53-58. During the course of transporting the right page 81 to the other side, the adhesive roller 42 rotates as it eventually separates itself from the moving page, and one of the plurality of fingers 53-58 moves on top of the next page and restrains it to remain flat. The forward cycle, which is depicted in FIG. 12, is completed when one of the two actuators 62 pass across the photoelectric sensor 61. This turns off the electric motor and stops the timing belt 60. This cycle must be repeated to turn the subsequent pages.

Similarly, in the reverse cycle, pressing the reverse button 23 on the keypad 20, or through the above-mentioned means, the electric motor is energized and through the gear reducer, clutch, and sprocket; the timing belt will be turned in a clockwise direction. At the same time, the stepper motor 48 rotates the left pickup arm 41 about its pivot point to reach a left page 82. The left pickup arm 41 then rotates away from the left page 82 to lift it up. The timing belt 60 rotates one of the plurality of fingers 53-58 clockwise and makes it go under the lifted page to transfer it to the right side of the book while one of the plurality of fingers 53-58 rolls over the next page and restrains it to remain flat. Finally, the timing belt is stopped when one of the two actuators 62 pass the photoelectric sensor 61. This completes the reverse page turn cycle.

The location and orientation of the pickup arms 40 and 41 are such that the lifting and the transport of the page is initiated as soon as the motor is energized, without any delays for resetting the position of the pickup arms. The length of the plurality of fingers 53-58 and the pickup arms 40-41 are such that they are located in the bottom margin of the book and do not noticeably interfere with the text of the book. Preferably, the contact point of each pickup arm on the page lies approximately 3″ away from the book spine to achieve a sufficient lifting force.

As is evident, the combination of biased support plate 30, and page ledges 36 results in a fixed and predictable contact point for pickup arms 40 and 41. This allows a subset of bound pages from the book to be selected, which can then be reliably turned by the mechanism. This further allows the use of variable timing profiles for the pickup arms as they move between the rest state to the page ledge and back up towards the rest state. A longer pause in the upward pickup arm trajectory is better suited for thin paper.

Although the present invention has been described in considerable detail with reference to certain preferred versions thereof, other versions are possible. Therefore, the spirit and scope of the appended claims should not be limited to the description of the preferred versions described herein. For example, the invention could be used in a page turner that was implemented in a scanning system for taking photographs or digital images of the pages. In such a case, it might be possible to dispense with many aspects of the page turner; for example only single directional movement might be needed, and only a single pickup arm might be used.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. An improved automatic page turner for turning selected bound pages, the automatic page turner comprising a frame, and one or more pickup arms rotatably coupled to the frame and capable of traveling along a trajectory, the improvement comprising:
means for separating the selected bound pages from remaining bound pages,
means for biasing the remaining bound pages against the separating means, and
means for rotating the one or more pickup arms through the trajectory with a timing profile,
thereby turning the selected pages.

2. The page turner of claim 1, the improvement further comprising means for varying the timing profile of the one or more pickup arms as it moves towards or away from the selected bound pages.

3. The page turner of claim 1, the improvement further comprising a paper thickness adjustor which alters the timing profile of the one or more pickup arms.

4. The page turner of claim 1, where the separating means comprises a page ledge connected to the frame.

5. The page turner of claim 1, where the biasing means comprises a support plate and one or more helical compressive springs.

6. The page turner of claim 5, where the support plate is bifurcated to support each side of the book independently.

7. An improved automatic page turner, the automatic page turner comprising a frame and a pickup arm, the improvement comprising:
a page ledge connected to the frame;
a support plate movably connected to the frame;
one or more springs biasing the support plate toward the page ledge;
a stepper motor connected to the pickup arm; and
a sensor in communication with the pickup arm.

8. A method for turning bound pages comprising:
selecting a subset of the bound pages for turning;
placing the subset of bound pages against one side of a page ledge;
biasing the remaining bound pages against the opposing side of the page ledge; and
energizing a motor assembly to turn at least one of the subset of bound pages.

9. The method of claim 6, further comprising turning the bound pages at a variable speed as a function of the weight of the bound pages.

10. The page turner of claim 7, where the sensor is a photoelectric sensor.
